(19) United States
(12) Patent Application Publication
(10) Pub. No.: US 2014/0036056 A1
(43) Pub. Date: Feb. 6, 2014

(54) MONITORING SYSTEM AND MONITORING METHOD THEREOF

(71) Applicant: HON HAI PRECISION INDUSTRY CO., LTD., New Taipei (TW)

(72) Inventor: HUNG-CHANG CHEN, New Taipei (TW)

(73) Assignee: HON HAI PRECISION INDUSTRY CO., LTD., New Taipei (TW)

(21) Appl. No.: 13/670,457

(22) Filed: Nov. 7, 2012

(30) Foreign Application Priority Data
Aug. 3, 2012 (TW) 101127911

(51) Int. Cl. H04N 7/18

(52) U.S. Cl. CPC H04N 7/188
USPC 348/78; 348/143

(57) ABSTRACT

A monitoring system includes a capturing unit for capturing images of the area in front of an electronic device to obtain images for video playback, a monitoring unit for monitoring the state of the electronic device, a communicating unit, a prompting unit, a detecting unit for detecting whether an abnormal event occurs in the monitoring area when the electronic device is in the unused state, and detecting whether the user is using the electronic device abnormally when the electronic device is in the working state, and a processor for transmitting the captured images to a preset accessing address via the communicating unit, and controlling the prompting unit to generate information when the user is detected to be using the electronic device abnormally. A monitoring method is also provided.

### BACKGROUND

1. Technical Field

The present disclosure relates to monitoring systems, and particularly to monitoring methods implemented by monitoring systems.

2. Description of Related Art

For security, people may install a camera in an electronic device (such as a television) in their home. The camera captures images of an area in the house, and then stores the captured images in a memory. But the people do not know the events happening in the house until they go home to access the images stored in the memory. Furthermore, when people use the electronic device for entertainment, people may nevertheless go to sleep in front of the device, this is not healthy and is a waste of power.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the four views.

FIG. 1 is a schematic view of a monitoring system applied in an electronic device in accordance with an embodiment.

FIG. 2 is a block diagram of a monitoring system in accordance with an embodiment.

FIGS. 3-4 show a flowchart of a monitoring method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

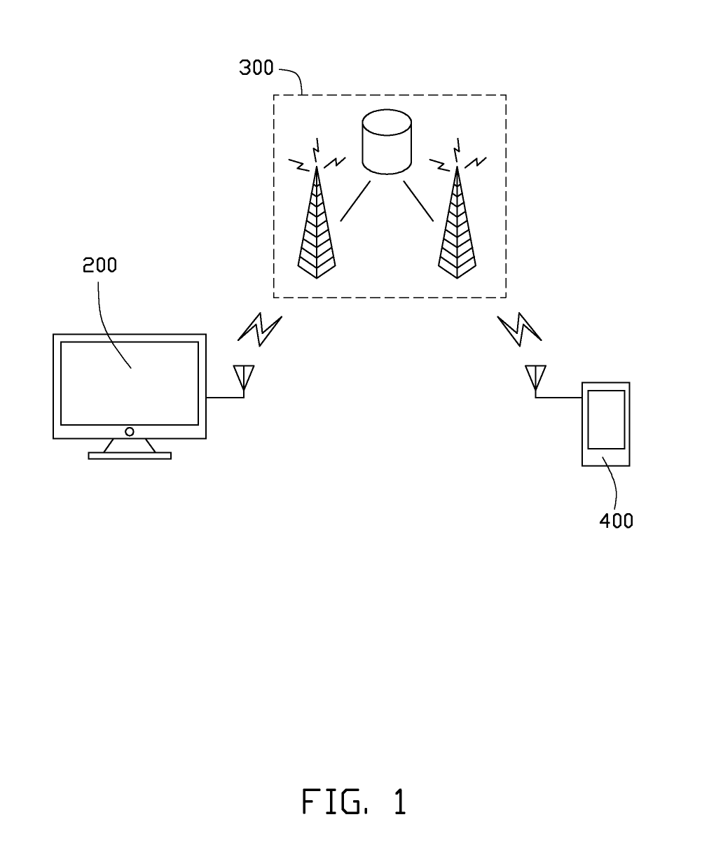

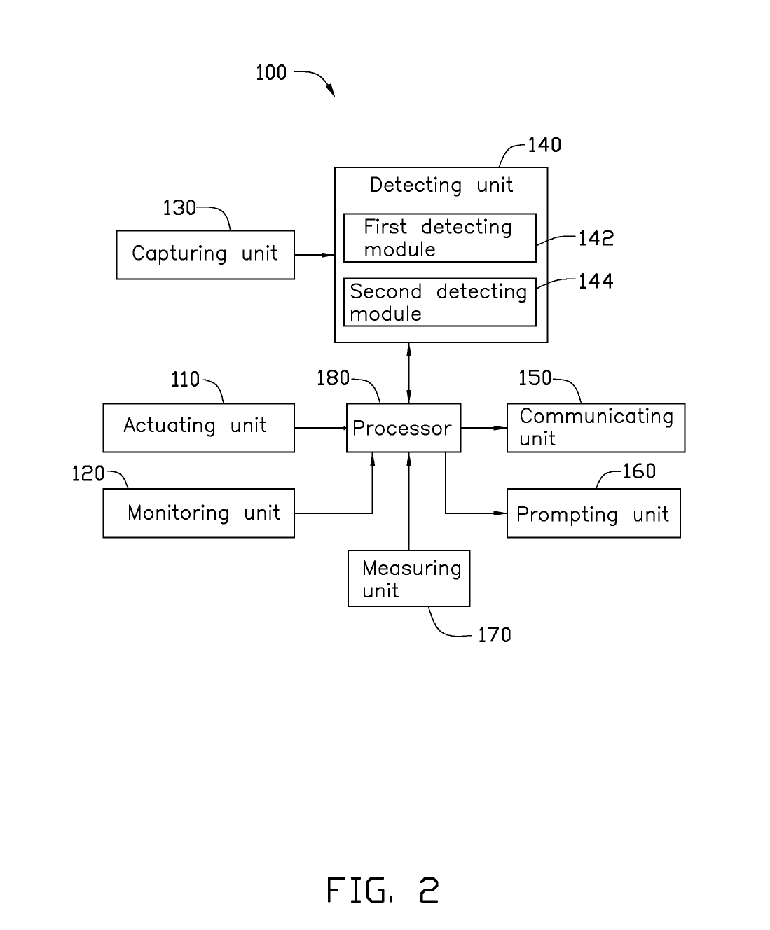

Referring to FIGS. 1 and 2, a monitoring system 100 applied in an electronic device 200 which may be in an unused state, and in a working state is provided. The unused state includes a standby state and an off state. The electronic device 100 may be a television, a set-top box, or a computer. The electronic device 200 in the embodiment is a television. The monitoring system 100 is adapted to capture images of an area in front of the electronic device 200 when the electronic device 200 is in the unused state and transmit the captured images to the user when an abnormality (as hereinafter defined) is detected. The monitoring system 100 is further adapted to detect whether the user is using the electronic device 200 abnormally (as hereinafter defined) when the electronic device 200 is in the working state and generate information to prompt the user if the user is detected using the electronic device 200 abnormally. The monitoring system 100 includes an actuating unit 110, a monitoring unit 120, a capturing unit 130, a detecting unit 140, a communicating unit 150, and a processor 180. The electronic device 100 further includes a prompting unit 160 and a measuring unit 170. The actuating unit 110, the monitoring unit 120, the capturing unit 130, the detecting unit 140, the communicating unit 150, the prompting unit 160 and the measuring unit 170 are all electrically connected to the processor 180 directly or indirectly.

The actuating unit 110 is adapted to generate a signal to start the monitoring system 100 when actuated. By virtue of the actuating unit 110, the user can selectively start the monitoring system 100. In the embodiment, the actuating unit 110 may be a button mounted on the electronic device 200, the actuating unit 110 generates the signal to start when the button is pressed.

The monitoring unit 120 is adapted to detect certain states of the electronic device 200. The monitoring unit 120 generates a first monitoring signal when the electronic device 200 is in the unused state, and generates a second monitoring signal when the electronic device 200 is in a working state.

The capturing unit 130 is electrically connected to the processor 180 via the monitoring unit 140. The capturing unit 130 is adapted to capture images of the monitored area in front of the electronic device 200 to obtain a plurality of consecutive images in response to an actuating signal. When the electronic device 200 is in the unused state, the capturing unit 130 obtains the images for recording events happening in the monitored area, and when the electronic device 200 is in the working state, the capturing unit 130 obtains the images of the user using the electronic device 200. In the embodiment, the capturing unit 130 is a camera mounted on a front surface of the electronic device 200.

The detecting unit 140 includes a first detecting module 142 and a second detecting module 144. When the electronic device 200 is in the unused state, the first detecting module 142 detects whether an abnormal event occurs in the monitored area according to the consecutive images, and if so to generate a first detecting signal. In the embodiment, the first detecting module 142 detects whether an object is detected to be in motion in the monitored area (this is one example of an abnormality detected in the unused state). In detail, the first detecting module 142 matches a current image with that of a previous frame via an autocorrelation of the characteristic values of the current and previous images, to obtain an area corresponding to movement, that is, an area over which movement has taken place. That is to say, the corresponding area appears in both of the current and previous images, and the correlation degree of the characteristic values of the corresponding area in both of the current and previous images is determined as 89%, for example. Therefore, the current and previous images can be matched via the autocorrelation of the characteristic values to obtain the corresponding area. Then, the first detecting module 142 compares the characteristic values of the corresponding area in both of the current and previous images to obtain an area subject to a path or track indicating an object in motion, which does not appear in the corresponding area of the previous image but does appear in the corresponding area of the current image. Therefore, an area with different characteristic values of the corresponding area in current and previous images is determined to be the area subject to an object in motion.

The second detecting module 144 is adapted to determine whether the object in motion is a person in response to the first detecting signal and further to generate a second detecting signal if the object in motion object is determined to be a person. In the embodiment, the second detecting module 144 determines whether the characteristics of a human face is in the corresponding area of the images by Face Template Matching technology and determines that the object in motion is a person if a determination as to facial characteristics can be made.

When the electronic device 200 is in the working state, the detecting module 140 is further adapted to detect whether the user is using the electronic device 200 abnormally and if so to generate a first prompt signal. In the embodiment, when the blink rate of the user eyelids during a predetermined time interval (such as 60 seconds) is less than a preset number of times, such as 3 times, the user is determined to have gone to sleep before turning off the electronic device 200, and this is an example of an abnormality detected in the working state. In detail, when the electronic device 200 is in the working state and the first detecting module 142 detects that a human face is in the images, the second detecting module 144 detects whether the blink rate of the user eyelids during the predetermined time value (60 seconds) is less than the preset number (3 times). A first prompt signal is generated if the number of blinks during the predetermined time value (60 seconds) is less than the preset number (3 times), to prompt the user to use the electronic device 200 normally.

The temperature measuring unit 170 measures the temperature of the user and further generates a second prompt signal if the temperature of the user is outside a predetermined range T0, such as (36.5° C.˜37.5° C.). When the measured temperature of the user is outside the predetermined range T0, the user may be warned as to an abnormal body temperature, and the second prompt signal is generated to inform the user as to an abnormal body temperature. The temperature measuring unit 170 can be further adapted to measure the ambient temperature around the electronic device 200.

The prompting unit 160 generates information to warn or prompt the user. The prompt information may be audible, visible text, or flickering LED lights, alone or in combination. For example, the prompting unit 160 generates an audible prompt saying: “you are tired, please turn off the electronic device,” and may simultaneously display a written and visual prompt “you are tired, please turn off the electronic device” in a display of the electronic device 200.

The processor 180 is adapted to transmit the captured images to a predetermined accessing address via the communication unit 150 and the communicating network 300 (see FIG. 1) when a second detecting signal is received. The predetermined accessing address may be, but is not limited to, an email address. For example, the predetermined accessing address can also be a portable communicating device 400 (see FIG. 1) carried by the user. The communication unit 150 may be constructed based on wireless or wire technology. When a user is not at home, the user can view events happening in the house by accessing the captured images through the predetermined accessing address at any time from a network.

The processor 180 is further adapted to control the prompting unit 160 to generate prompt information when a first or second prompt signal is received. For example, on receipt of the first prompt signal, the processor 180 controls the prompting unit 160 to generate an audible and vocal prompt: “you are tired, please turn off the electronic device”. On receipt of the second prompt signal, the processor 180 controls the prompting unit 160 to generate an audible and vocal prompt: “your temperature is abnormal”. The processor 180 further displays the ambient temperature measured by the temperature measuring unit 170 in the display, to allow the user to know the temperature around the housing.

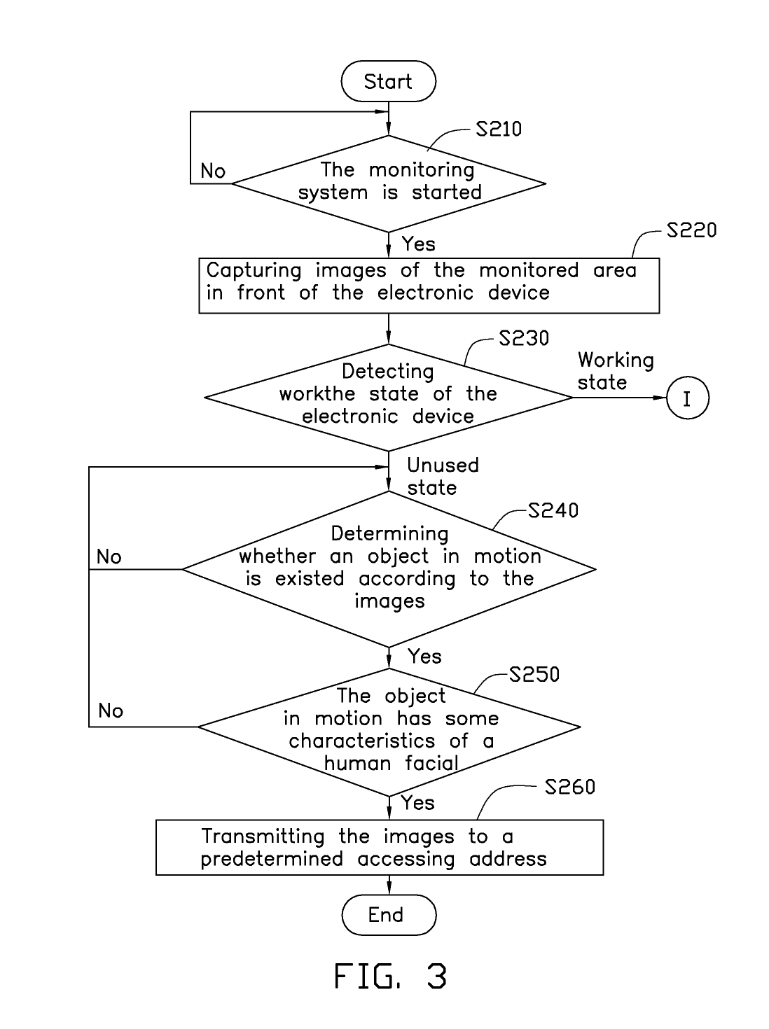

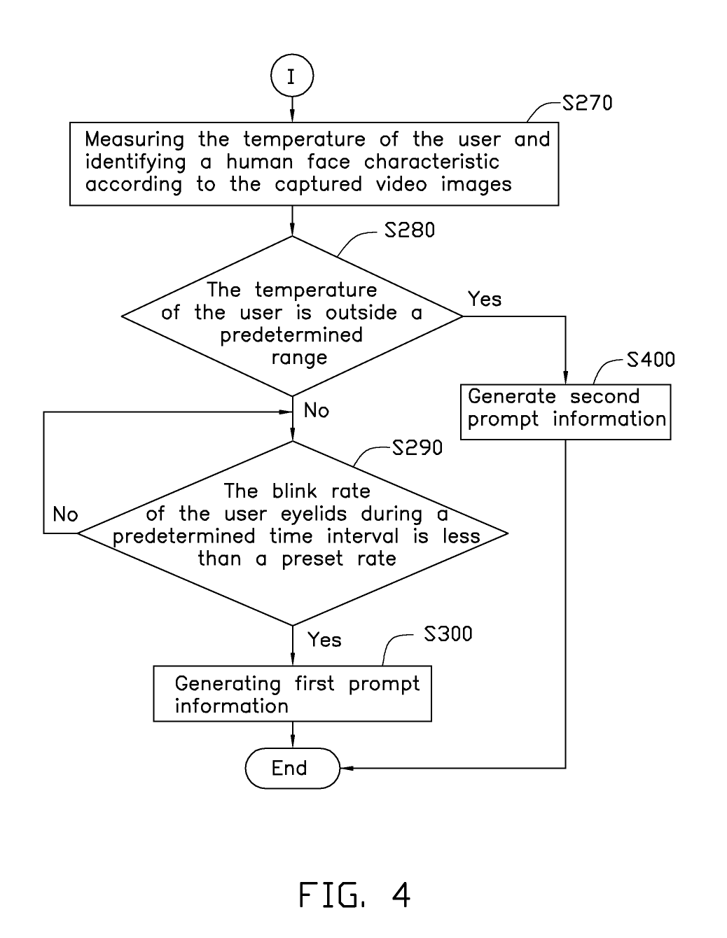

Referring to FIGS. 3-4 a monitoring method is provided. The method may be applied in a monitoring system 100 capable of capturing images for video playback. The monitoring system 100 is applied in an electronic device 200. The electronic device 100 may be a television, a set-top box, or a computer. The method includes the following steps:

In step S210, determining whether the monitoring system 100 is started. If the monitoring system 100 is started, step S220 is implemented. If the monitoring system 100 is not started, step S210 is repeated. In the embodiment, the monitoring system 100 includes an actuating unit, the actuating unit 110 is a button mounted on the electronic device 200, the user can start the monitoring system 100 by pressing the button of the actuating unit 110.

In step S220, the capturing unit 130 captures images of the area in front of the electronic device 200.

In step S230, the monitoring unit 120 detects the state of the electronic device 200. If the electronic device 200 is detected to be in the unused state, the procedure goes to step S240; if the electronic device 200 is detected to be in the working state, the procedure goes to step S270.

In step S240, the first detecting unit 142 determines whether an object is in motion by analyzing consecutive images. If an object in motion exhibits, the procedure goes to step S250; and if there is no object in motion, the procedure returns to step S240.

In step S250, the second detecting module 144 detects whether the object in motion has some characteristics of a human face. If the object in motion has some characteristics of a human face, the procedure goes to step S260; and if not, the procedure returns to step S240. In the embodiment, the second detecting unit 144 identifies facial characteristics by Face Template Matching technology.

In step S260, the processor 180 transmits the captured images to a predetermined accessing address via the communicating unit 150. The predetermined accessing address may be, but is not limited to, an email address. When a user is not at home, the user can view the events happening in the house by accessing the transmitted images through the predetermined accessing address at any time from a network.

In step S270, the temperature measuring unit 170 measures the temperature of the user and the second detecting module 144 identifies human facial characteristics according to the captured images.

In step S280, the temperature measuring unit 170 further detects whether the temperature of the user is outside a predetermined range. If the temperature of the user is within a predetermined range, the procedure goes to step S290; if the temperature of the user is outside a predetermined range, the procedure goes to step S400.

In step S290, the second detecting module 144 further detects whether the blink rate of the user eyelids during a predetermined time interval (for example, 60 seconds) is less than a preset number (for example, 3 times). If the number of blinks during the predetermined time interval is less than the preset number, the procedure goes to step S300; and if not, the procedure returns to step S290.

In step S300, the processor 180 controls the prompting unit 160 to generate a first prompt information, such as: you are tired, please turn off the electronic device.

In step S400, the processor 180 controls the prompting unit 160 to generate a second prompt information, such as: your temperature is abnormal.

It is to be understood, however, that even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A monitoring system applied in an electronic device which comprises an unused state and a working state, comprising:
a capturing unit for capturing the monitoring area in front of the electronic device to obtain a plurality of images;
a monitoring unit for monitoring states of the electronic device;
a communicating unit;
a prompting unit for generating prompt information;
a detecting unit for detecting whether an abnormal event occurs in the monitoring area according to the captured images when the electronic device is in the unused state, and detecting whether the user uses the electronic device abnormally when the electronic device is in the working state; and
a processor for transmitting the captured images to a preset accessing address via the communicating unit when an abnormal event occurs in the monitoring area, and controlling the prompting unit to generate first prompt information when the user is detected to use the electronic device abnormally.

2. The monitoring system according to claim 1, wherein the predetermined accessing address is an Email address.

3. The monitoring system according to claim 1, wherein the detecting unit comprises a first detecting module, the first detecting module detects whether an object in motion exists according to the capture images when the electronic device is in the unused state and determines that an abnormal event occurs in the monitored area if an object in motion is detected.

4. The monitoring system according to claim 3, wherein the detecting unit further comprises a second detecting module, the second detecting module detects whether the object in motion has some characteristics of a human face; the processor transmits the captured images to the preset accessing address via the communicating unit if the object in motion exhibits human facial characteristic.

5. The monitoring system according to claim 4, wherein the second detecting module further detects whether the blink rate of the user eyelids during a predetermined time interval is less than a preset rate when the electronic device is in the working state and determines the user uses the electronic device abnormally if the blink rate of the user eyelids during the predetermined time is less than the preset rate.

6. The monitoring system according to claim 5, wherein the processor controls the prompting unit to generate the first prompt information if the blink rate of the user eyelids during the predetermined time is less than the preset rate.

7. The monitoring system according to claim 1, further comprising a temperature measuring unit; wherein the temperature measures unit measures the temperature of the user when the electronic device is in the working state, and further detects whether the temperature of the user is outside a predetermined range; the processor controls the prompting unit to generate second prompt information if the temperature of the user is outside the predetermined range.

8. The monitoring system according to claim 7, wherein the temperature measuring unit further measures the ambient temperature around the electronic device; the processor further displays the ambient temperature around the electronic device.

9. The monitoring system according to claim 1, further comprising an actuating unit for selectively starting the monitoring system when being actuated.

10. A monitoring method implemented by a monitoring system applied in an electronic device which comprises an unused state and a working state, the monitoring system comprising a capturing unit, the monitoring method comprising:
capturing images of a monitored area in front of the electronic device;
monitoring states of the electronic device;
detecting whether an abnormal event occurs in the monitoring area according to the captured images when the electronic device is in the unused state and transmitting the captured images to a preset accessing address via the communicating unit when an abnormal event occurs in the monitoring area; and
detecting whether the user uses the electronic device abnormally when the electronic device is in the working state and controlling the prompting unit to generate first prompt information when the user is detected to use the electronic device abnormally.

11. The monitoring method according to claim 10, further comprising:
detecting whether an object in motion exhibits according to the capture images when the electronic device is in the unused state; and
determining that an abnormal event occurs in the monitored area if an object in motion is detected.

12. The monitoring method according to claim 11, further comprising:
detecting whether the object in motion has some characteristics of a human face; and
transmitting the captured images to the preset accessing address via the communicating unit if the object in motion has some characteristics of a human face.

13. The monitoring method according to claim 10, further comprising: wherein the predetermined accessing address is an Email address.

14. The monitoring method according to claim 10, further comprising:
providing an actuating unit for selectively starting the monitoring system; and
if the actuating unit is actuated, the step of capturing the images of the monitored area in front of the electronic device is implemented.

15. The monitoring method according to claim 10, further comprising:
detecting whether the temperature of the user is outside a predetermined range; and
generating second prompt information if the temperature of the user is outside the predetermined range.

16. The monitoring method according to claim 15, further comprising:
measuring the ambient temperature around the electronic device; and
displaying the measured ambient temperature around the electronic device.

17. The monitoring method according to claim 10, further comprising:
detecting whether the blink rate of the user eyelids during a predetermined time interval is less than a preset rate when the electronic device is in the working state; and
determining that the user uses the electronic device abnormally if the blink rate of the user eyelids during the predetermined time is less than the preset rate.
